(19) United States
(12) Patent Application Publication
(10) Pub. No.: US 2017/0290466 A1
(43) Pub. Date: Oct. 12, 2017

(54) TOUCHLESS TIMER AND PRODUCT MANAGEMENT FOR FOOD HOLDING DEVICES

(71) Applicant: Cleveland Range, LLC, Cleveland, OH (US)

(72) Inventors: Kenneth Lee LUNDBERG, Land O Lakes, FL (US); Nicholas PATTERSON, Trinity, FL (US); Daryl Gregory ERBS, Tarpon Springs, FL (US); Andrew Michael BEST, Tampa, FL (US); Charles E MOSES II, New Port Richey, FL (US); John BOOTH, Tampa, FL (US); Ricardo ACOSTA, Trinity, FL (US)

(21) Appl. No.: 15/484,940

(22) Filed: Apr. 11, 2017

Related U.S. Application Data
(60) Provisional application No. 62/321,056, filed on Apr. 11, 2016.

(51) Int. Cl. A47J 39/00; H05B 1/02

(52) U.S. Cl. CPC A47J 39/006; H05B 1/0252

(57) ABSTRACT

The devices, methods, and algorithms of the present disclosure provide a hot food holding cabinet to detect the presence and uniquely identify a plurality of food holding trays within a plurality of food holding locations within a hot food holding cabinet. There can also be multiple, separate food holding cabinets that are linked together. Timing and other functions related to the storage of the food holding trays are initiated automatically, without any manual input from a user. This allows for the automated initiation and tracking of product quality parameters by the cabinet computer. The parameters can include product timers and holding profiles, and whether the food holding trays are removed, transferred between bins in a single cabinet, or transferred between separate cabinets.

### CROSS-REFERENCE TO RELATED APPLICATIONS

The present application claims the benefit of U.S. Provisional Application Ser. No. 62/321,056, which is herein incorporated by reference.

### BACKGROUND OF THE DISCLOSURE

### 1. Field of the Disclosure

The present disclosure relates to devices for holding food products at desired temperatures while they are waiting to be served to a customer. More particularly, the present disclosure relates to devices and associated methods algorithms for holding food products before service, which do not require a user to manually initiate and control the timing of the food product holding.

### 2. Description of the Related Art

Hot holding cabinets are used in restaurants to store a plurality of cooked food products when the cook time for a product is longer than the customer expectation for wait time. This allows the restaurant to prepare food ahead of time, in order to meet the customer's expectation of receiving a food product immediately or shortly after ordering. These holding cabinets have storage slots for food product trays, a heat source to keep the food product and their trays at a desired serving temperature, and a product tracking system to perform specific functions such as time tracking, product type identification, product status indications, process indications, audible feedback and alarm generation and display. Cabinets are supplied with prepared food products from a cooking device (e.g., a grill) and are generally capable of holding between 1 to 20 individual trays.

The product tracking systems are generally comprised of a display (e.g., segmented LED, touch screen) near or correlated to a food holding location in the device, a button (e.g., PCB tactile button, touch screen) to activate/deactivate different functions, and an auxiliary visual indicator (e.g., LED's, LCD display) to communicate the state of the food in the food holding tray relative to key quality metrics. Generally the product tracking systems indicate to the operator where to place the product (product name), the amount of time left before the product must be discarded (hold time), which product tray to use product from, (use first), when to cook more of the product (cook time) and lid and bottom type requirements for holding the product optimally.

Currently available product tracking systems such as those described above require a manual button press to initiate the product tracking sequence. This user-operated button press registers the food holding tray to a food holding location and initiates a sequence of pre-determined logic functions. The initiation of this sequence is imperative to all process and quality functions the holding cabinet performs. One such device is shown in U.S. Pat. No. 7,232,062, to Salerno. As stated at col. 7, I. 12-41, the worker or user must press a manual timing switch both when placing a food pan in a holding station, and when removing it.

In these devices, failure to initiate the process at the correct times adversely affects the quality control process for the food in the holding cabinet. Due to the fast pace in the restaurant kitchen environment, operators often skip, forget, or misuse the manual process initiation step (intentionally or unintentionally), and the quality control process is disrupted or lost. Over an extended period of time, this ultimately results in a negative variance of the food quality being served to customers.

Also, in higher demand restaurants, there are commonly multiple holding cabinets in the kitchen. In this type of restaurant, bulk holding cabinets are used to hold large batches of cooked products and separate, smaller cabinets are used at food assembly locations. Food products within food holding trays are moved from a food holding location on one cabinet to a food holding location on another cabinet. Transferring the product information during a product move generally requires a complex sequence of button presses on both the origination and destination holding cabinet. Again, these sequences are not consistently utilized in the fast paced kitchen environment and food quality is compromised.

Accordingly, there is a need to address these disadvantages of currently available systems.

### SUMMARY OF THE DISCLOSURE

The device, methods, and algorithms of the present disclosure eliminate the need for manual initiation of a warming or storage cycle and manual product transfer steps when storing food products before service. The present disclosure provides automatic registration of a food holding tray when placed in a holding cabinet, via hands-free registration of the tray (e.g., with an RF tag or bar code). The present disclosure also automatically transfers critical product information during a product move from one cabinet to a different cabinet, or from one bin to another bin within the same cabinet, again with hands-free registration. This allows the product tracking sequence to be automatically initiated whenever a food holding tray is placed in a food holding location. This system is easier for an operator to use, insures higher compliance with product tracking (which is critical to quality control), and allows for accurate tracking of product information when product is transferred from cabinet to cabinet.

Thus, in one embodiment, the present disclosure provides a system for storing food products at heated temperatures, comprising a cabinet, a tray for holding the food products, wherein the tray has a transceiver connected thereto, and the transceiver has identity information relating to the tray, a storage bin in the cabinet for receiving the tray, wherein the storage bin has a reader therein, for reading and the information from the transceiver, a heater in the storage bin, for supplying heat to the tray, and a processor in the cabinet. After a user places the tray in the bin, the processor receives the identity information from the reader, and performs at least one of the following functions: registering the tray to the bin, initiating a timer for the time that the tray is within the storage bin, initiating a change in the temperature within the bin by changing an amount of power supplied to the heater, prompting a user for input, and initiating an audible or visual alarm or displaying visual indicators.

In another embodiment, the present disclosure provides a method of storing food products in a heated system. The system comprises a cabinet, a tray for holding the food products, wherein the tray has a transceiver connected thereto, and the transceiver has identity information relating to the tray, a storage bin in the cabinet for receiving the tray, wherein the storage bin has a reader therein, for reading and the information from the transceiver, and a heater in the storage bin, for supplying heat to the tray. The method comprises the steps of: placing the tray into the bin; reading the identity information from the transceiver with the reader; and using the identity information to perform at least one of the following steps: registering the tray to the bin, initiating a timer to track the time that the tray is within the bin, initiating a change in the holding temperature within the bin by changing the amount of power supplied to the heater, initiating a holding profile for the tray, prompting a user for input, and initiating an audible or visual alarm or displaying visual indicators.

### BRIEF DESCRIPTION OF THE DRAWINGS

FIG. 1 is a side, perspective view of a cabinet of the present disclosure.

FIGS. 2a and 2b are side view of trays that are used in the cabinet of FIG. 1.

FIG. 3 is a schematic drawing of the cabinet of FIG. 1.

FIG. 4 is a flow chart showing one process for moving and reading trays according to the present disclosure.

FIG. 5 is a second flow chart showing additional process steps for reading and transferring trays according to the present disclosure.

### DETAILED DESCRIPTION OF THE DISCLOSURE

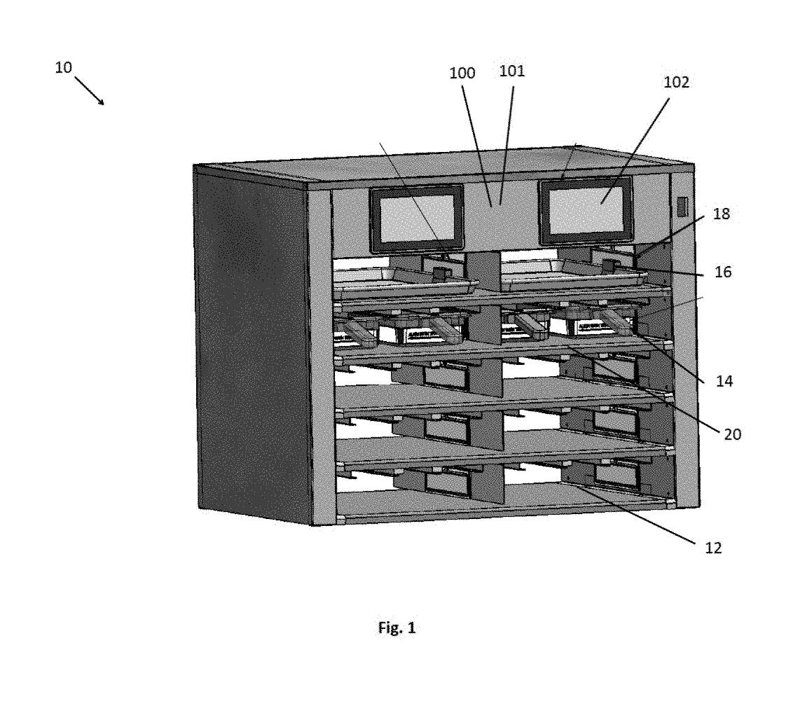

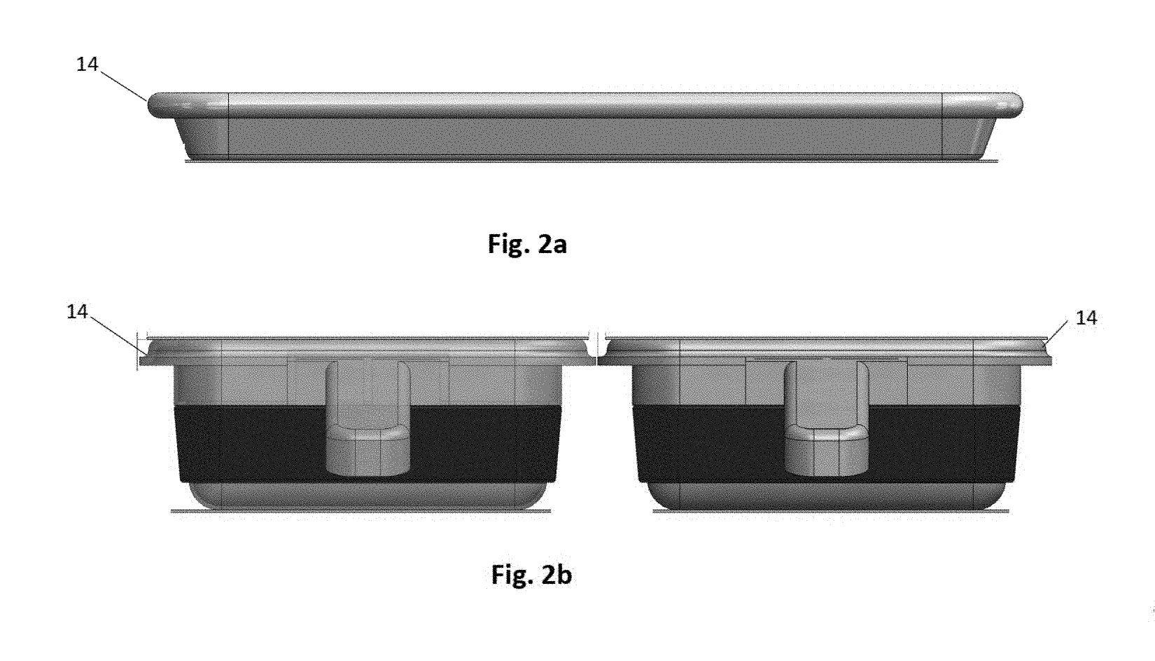

Referring to FIGS. 1-3, and in particular FIG. 1, cabinet 10 of the present disclosure is shown. Cabinet 10 has a plurality of tray storage bins 12. Each of tray bins 12 can receive one or more of trays 14, the latter of which holds one or more food products (not shown). As shown in FIGS. 2a and 2b, trays 14 can either have a shallow profile with relatively long sides (FIG. 2a), or be deep with shorter sides (FIG. 2b). The suitable type of tray 14 will depend on the food product to be stored therein. Trays 14 have a transceiver 16 located thereon or connected thereto. As discussed in greater detail below, transceiver 16 can store identity information relating to its associated tray 14. A reader 18 associated with each of bins 12 collects the information from transceiver 16 that relates to the associated tray 14. This information is then relayed to a central processor 100, which tracks the location and identity of each tray 14. Each bin 12 also has a heater 20 associated therewith. As discussed in greater detail below, processor 100 can be in electrical communication with each heater 20, and control the state (on/off) and amount of power supplied to heater 20 as needed, to keep any food products in tray 14 warm.

Processor 100 has an algorithm 101 thereon which calculates and keeps track of such information as, but not limited to, the identity of a tray 14, its location, how long it has been in that location, how long it has been kept heated at an elevated temperature, and how much longer it can be kept heated at the elevated temperature and still satisfy desired food product quality standards. Processor 100 and algorithm 101 can display information relating to each of trays 14 on a user interface (UI) 102. This information displayed on UI 102 can be, but is not limited to, the type of food product in each tray 14, how long the food in each tray has been heated, how much longer tray 14 can be kept heated before it fails desired product standards, and when too much time has elapsed for the food product to be served to a customer.

Advantageously, all of the above is achieved without the user of cabinet 10 having to input or initiate any programs manually. The user places tray 14 in an available bin 12, and processor 100 and algorithm 101 track all of the relevant information automatically. This eliminates problems with currently available systems. Currently, if a user places a tray into a heated storage bin and forgets to initiate a timer, information relating to the food product is lost. The product may be heated for too long, rendering it unsuitable for serving to a customer. This leads to waste and/or unsatisfied customers. Cabinet 10 of the present disclosure eliminates these disadvantages.

Although the present disclosure is primarily directed to keeping trays 14 at elevated temperatures within bins 12, the devices and methods of the present disclosure could be used to keep trays 14 at ambient temperatures, or to cool them as well. In addition, the term “bin” is used for simplicity, to describe a fully- or semi-enclosed location or zone capable of storing and holding one or more trays.

Each of trays 14 will have a part number and unique identification number associated therewith, stored in transceiver 16. The part number can be associated with a specific food product in tray 14. In this way, processor 100 can keep track both of the identity of tray 14, through its identification number, and the food product therein, via the part number. This part number will indicate the desired heating and storage time for the product in tray 14. A user can input the food product part number associations through interface 102, or via a separate PC application.

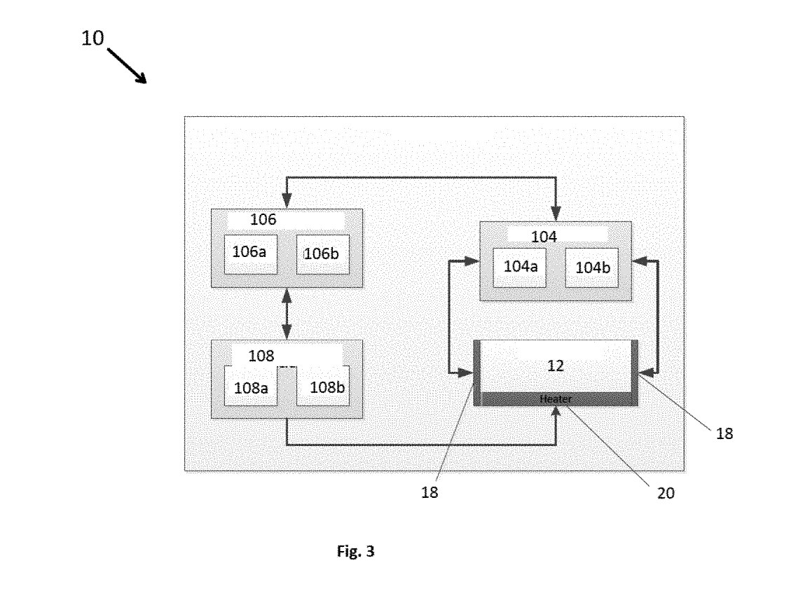

Referring to FIG. 3, a schematic drawing of cabinet 10 is shown. As discussed above, a user places a tray into bin 12. Cabinet 10 has transceiver reader board 104, with transceiver processor 104a and memory 104b, UI board 106 with UI processor 106a and UI memory 106b, and temperature control 108 with control processor 108a and control memory 108b. Thus, in the shown embodiment, processor 100 is split up into three separate processors, namely transceiver processor 104a, interface processor 106a, and temperature control processor 108a. The present disclosure contemplates that there can be one processor 100 that performs all of the functions described herein, or that processor 100 can be separated into two or more separate processors.

Bin 12, reader 18, reader board 104, UI board 106, temperature control board 108, and heater 20 are all in electrical communication with one another. When a tray is placed in bin 12, reader 18 reads the information associated with the tray, and relays it to reader board 104. Board 104 then communicates this information to processor 106a and memory 106b of UI board 106. UI processor 106a can display relevant information to the user on interface 102. As the name implies, temperature control processor 108a monitors and controls the temperature of individual bins 12 with heaters 20. Temperature set points can be sent from UI processor 106a, and additional or reduced power can be supplied to heaters 20 as needed. The temperature values of heaters 20 can be reported from control processor 108a back to UI processor 106a. Thus, in this embodiment, UI processor 106a can be an aggregator of the data collected by the other processors 104a and 108a. Again, all of the above monitoring of storage time and heater control is done without any manual input from a user.

The transceivers 16 in the food holding tray 14 can either be passively or actively powered. In the former, the transceivers 16 are powered by readers 18. In the latter, transceivers 16 can have their own power supply, such as a battery. Readers 18 can be powered from the incoming AC electrical power in cabinet 10. In the shown embodiments, transceivers 16 and readers 18 are non-contact, non-optical devices such as radio-frequency devices. The present disclosure contemplates other devices for relaying information from transceiver 16 to reader 18, such as with bar-codes or two-dimensional codes and their associated readers, or magnetic or tape devices. An essential feature of trays 14, transceivers 16, and readers 18 is to be able to consistently and robustly detect the presence of a tray 14 in a bin 14, but not detect neighboring trays 14 unintentionally. There may be one or more transceivers 16 in each tray 14.

The transceivers 16 may be removably connected to the associated tray 14, along interior or exterior surfaces of tray 14. Transceivers 16 may also be molded or otherwise integrally formed into tray 14. There may also be multiple readers 18 for each bin 12.

In one embodiment, transceiver 16 is a one-way communication device, meaning that it only relays information to reader 18. Reader 18 does not write any information back to transceiver 16. In this embodiment, no information about the food products, their location, or the amount of time they have been kept heated is stored on tray 14 or in transceiver 16, but rather on processor 100. This is an improvement over currently available systems that write and store such information on the tray itself. Thus, device 10 does not rely on the clocks being in sync. The current time of day is sent when a tray is transferred to another cabinet, so the expiration time is offset accordingly. For example, if the system times are ten seconds off or out of sync, the expiration time for the food in tray 14 is adjusted by ten seconds). Furthermore, losing the signal during the write process could corrupt the data in transceiver 16.

Heaters 20 can be a number of suitable devices for providing heat to bin 12 and tray 14. They can be inductive, conductive (e.g., heated plates), convective (e.g., hot air flow), radiant (e.g. heat lamps, calorimeter rods), and any combination thereof. The heaters 20 are regulated by processor 108a to achieve desired temperature, as described above.

As discussed above, there is one heater 20 for each bin 12. A tray 14 may be in one bin 12, while an adjacent bin 12 is empty. If an operator were to move a tray 14 from one bin 12 to another, as previously discussed, processor 100 will track tray 14 accordingly. However, the heater 20 in the previously empty bin 12 will be inactive until a tray 14 is placed therein. Thus, in one embodiment, the heaters 20 in empty bins 12 may be kept at a reduced (e.g., half) power. When a tray 14 is placed in the empty bin 12, heater 20 will come up to the desired heat level in a reduced amount of time.

In the shown embodiment, cabinet 10 is a cabinet with ten bins 12, in a two-by-five arrangement. Each bin 12 can have space for one or two trays 14. In the embodiment shown in FIG. 1, for example, top bins 12 each larger tray 14, but the bins lower down store two of the narrower trays 14. The present disclosure contemplates cabinets with anywhere from one bin 12, to one or more bins. In one embodiment there are up to and equal to twenty bins 12. In any of these embodiments, bins 12 could fit multiple trays 14. The cabinets may be sized to fit different needs in different areas of the restaurant. For example, in a service area near the front of the establishment, a smaller cabinet with, for example, four bins 12 may be appropriate. In the rear of the establishment, it may be suitable to have a larger cabinet with up to 20 bins.

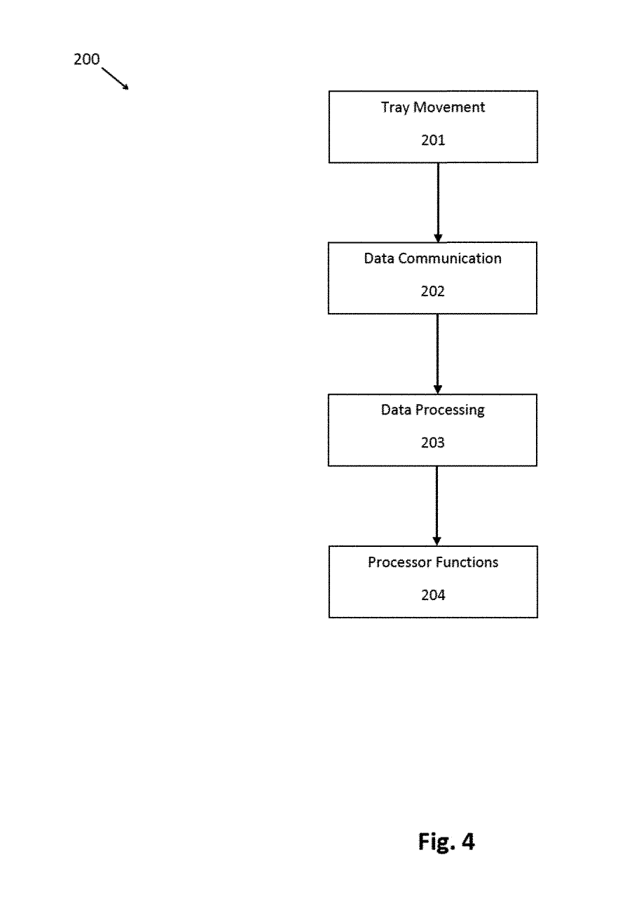

Referring to FIG. 4, a process 200 for receiving a tray 14 is shown. As previously discussed, a single or multiple transceivers 16 are built into or connected to each tray 14, to uniquely identify each tray 14. A single or multiple readers 18 are built into each bin 12, to uniquely identify each food holding location. The process 200 for identifying a food holding tray in a food holding location comprises the following steps:

Step 201, tray 14 is placed in a bin 12;

Step 202, transceiver 16 and reader 18 communicate a pre-determined set of information to processor 100;

Step 203, processor 100 identifies which reader 18 received the communication, and the ID of the food holding tray transceiver 16;

Step 204, processor 100 uses the above information to perform logical functions which may include, but are not limited to: initiating a timer to track the time that tray 14 is within bin 12, initiating a change in the holding temperature within bin 12 (e.g., by changing the power supplied to heater 20), initiating a holding profile for tray 14 (time versus temperature), prompting a user for input, and initiating an audible or visual alarm or displaying visual indicators. The holding profiles define how long to hold the food and at what temperature. They could also define multiple stages where the temperature is different throughout each stage.

Another significant advantage of the devices of the present disclosure as compared to currently available systems is that the devices, methods, and algorithms disclosed therein can accommodate for multiple devices or cabinets 10 within the same establishment. When multiple cabinets 10 are in the same location, the cabinets 10 may be connected to one another to allow communication of information between separate cabinets 10 and to the internet. Multiple cabinets could be connected to one another with a wired (e.g., Ethernet) or wireless (e.g., WiFi) connection. Thus, even if a user moves a tray 14 from one cabinet 10 to a separate cabinet 10, processor 100 and algorithm 101 allow for the tracking of the tray 14 across multiple cabinets 10. Processor 100 will thus know how much longer a food product in a specific tray 14 can be kept heated before being served, even when that tray 14 is moved from one cabinet 10 to another.

In this embodiment, if a tray 14 arrives at a bin 12, processor 100 will inquire all connected cabinets 10 for information associated with the transceiver 16 on tray 14. If tray 14 was previously registered to another bin 12, either within the same cabinet 10 or another cabinet 10, the associated information is transferred to the new cabinet 10 and/or bin 12 automatically. This allows inter- and intra-cabinet transfers to be handled in identical fashion.

In this embodiment, with multiple cabinets 10, each cabinet 10 may be of a different size and with a different number of bins 12. Again, this is because the organization of the restaurant or space constraints may mean that certain sizes are more suitable for different areas.

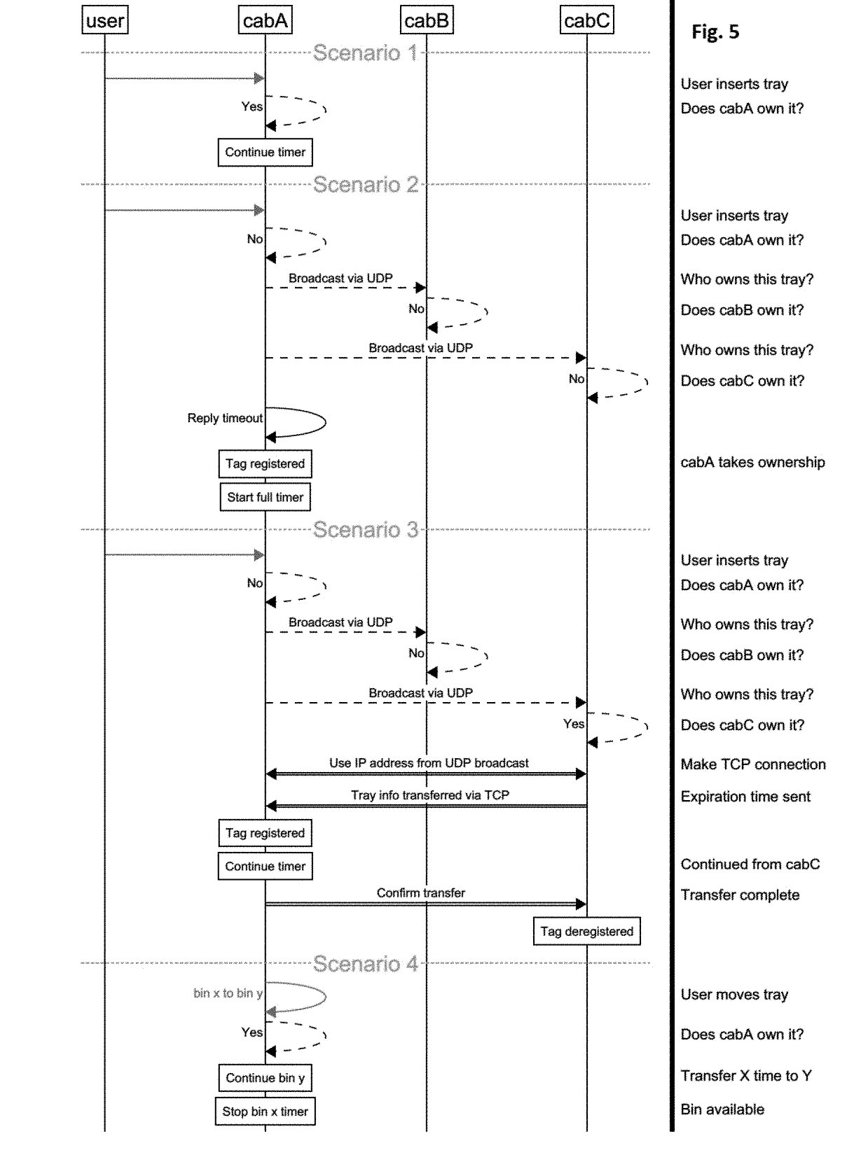

Referring to FIG. 5, a process diagram for an embodiment where there are multiple cabinets 10 is shown. Here, there are three cabinets 10, referred to as cabA, cabB, and cabC. In a Scenario 1, a user inserts tray 14 into a bin 12 in cabA. Processor 100 determines whether tray 14 is registered to cabA, meaning that it had previously been in either the same or a different bin 12 within cabA. If the answer is yes, then processor 100 continues a timer associated with the amount of time tray 14 has been in cabA.

Scenario 2 of FIG. 5 illustrates what happens when a user inserts a tray 14 into cabA, and tray 14 had not previously been associated with or located in cabA. Processor 100 will check with the other cabinets in the system, namely cabB and cabC, to see if tray 14 is registered with any of them. If not, processor 100 gives ownership of tray 14 to cabA, by registering the information in the transceiver 16 to cabA, and starting the necessary timers.

In Scenario 3, a user places tray 14 into cabA. As in Scenario 2, processor 100 surveys cabB and cabC to determine if tray 14 had been registered in either of those two locations. In Scenario 3, processor 100 determines that tray 14 had previously been located in cabC. Processor 100 then transfers all of the information associated with tray 14 and transceiver 16 from cabC to cabA, continues the timer, and deregisters tray 14 from cabC. Scenario 3 can be applicable when a user either deliberately or inadvertently transfers tray 14 before its associated timer has lapsed. For example, tray 14 can be placed in cabC, and have a timer of fifteen minutes associated therewith, reflecting the maximum amount of time that food in tray 14 can be heated before it needs to be served to a customer. If a user removes tray 14 from cabC after six minutes and places it in cabA, processor 100 will accommodate for this. Processor 100 will deregister tray 14 from cabC, and restart the timer and heater for tray 14 in cabA (i.e., at six minutes, with nine minutes left).

In Scenario 4, a user transfers tray 14 from one bin 12 in cabA into another bin 12 within the same cabA. Processor 100 detects this, and sets the timers accordingly for the first and second bins 12.

Algorithm 101 of the present disclosure can have a function whereby the state of all the readers 18 in each of bins 12 is saved to memory (“update antenna data array”). This step prevents the data collected during operation to be saved in the event of a power loss or system interruption.

In other embodiments, algorithm 101 may have additional features that improve the user experience. Algorithm 101 may control UI 102 to display the remaining time on all food trays 14 within a cabinet 10, and identify the one that should be drawn from first based on the least amount of time remaining. Algorithm 101 may also be able to determine when a tray 14 has been out of the cabinet for too long a time, and alert the user that the food therein is no longer usable. For example, if a user withdraws tray 14 from cabinet 10 to retrieve a food product, and forgets to place tray 14 back into cabinet 10 within a set period of time, algorithm 101 and processor 100 can track this. Another feature would allow a user to deregister a tray 14 from cabinet 10 by waving it over an antenna in a separate part of the restaurant. For example, a user may wish to withdraw a tray 14 at the end of a business day, to dispose of food therein, and/or clean tray 14. There can be a separate antenna (not shown) in communication with processor 100 and algorithm 101 that allows the user to deregister tray 14 by bringing it into proximity with the antenna.

Although the present disclosure has described heating bins 12 and the food products therein, cabinet 10, processor 100, and algorithm 101 can operate without heating the food. In this embodiment, processor 100 would track the food products and trays 14 passing between bins 12 without necessarily keeping them heated.

In another embodiment, processor 100 can be configured to provide an alarm or indication when a tray 14 is placed in a bin 12 where it is not registered or expected. The alarm can be an audio alarm, or can be a display on UI 102.

The present disclosure having been thus described with particular reference to the preferred forms thereof, it will be obvious that various changes and modifications may be made therein without departing from the spirit and scope of the present invention as defined in the appended claims.

1. A system for storing food products at heated temperatures, comprising:
a cabinet;
a tray for holding the food products, wherein the tray has a transceiver connected thereto, and the transceiver has identity information relating to the tray;
a storage bin in the cabinet for receiving the tray, wherein the storage bin has a reader therein, for reading the information from the transceiver;
a heater in the storage bin, for supplying heat to the tray; and
a processor in the cabinet,
wherein, after a user places the tray in the bin, the processor receives the identity information from the reader, and performs at least one of the following functions: registering the tray to the bin, initiating a timer associated with the tray for the time that the tray is within the storage bin, initiating a change in the temperature within the bin by changing an amount of power supplied to the heater, prompting a user for input, and initiating an audible or visual is alarm or displaying visual indicators.

2. The system of claim 1, wherein the processor performs the functions automatically after the user places the tray in the bin, without any further input from the user.

3. The system of claim 1, wherein the bin is a plurality of bins, each having a reader and a heater associated therewith.

4. The system of claim 1, further comprising a user interface for displaying information relating to the tray and/or the bin.

5. The system of claim 4, wherein the processor is three separate processors, one each associated with the reader, the user interface, and the heater.

6. The system of claim 3, wherein the processor further performs the function of determining whether the user has moved the tray from one of the bins to another of the bins.

7. The system of claim 6, wherein the processor initiates the timer, and if the user has moved the tray from a first bin to a second bin, the processor transfers information associated with the timer from the first bin to the second bin.

8. The system of claim 1, wherein the transceiver is a read-only device.

9. The system of claim 1, wherein the cabinet is a plurality of cabinets, wherein each of the cabinets has a bin therein, and a heater associated with the bin.

10. The system of claim 9, wherein the processor further performs the function of determining whether the user has moved the tray from a bin in one of the cabinets to a bin in another of the cabinets.

11. The system of claim 10, wherein the processor initiates the timer, and if the user has moved the tray from a first bin to a second bin, the processor transfers information associated with the timer from the first bin to the second bin.

12. A method of storing food products in the heated system of claim 1, comprising the steps of:
placing the tray into the storage bin;
reading the identity information from the transceiver with the reader;
using the identity information to perform at least one of the following steps: registering the tray to the bin, initiating a timer to track the time that the tray is within the bin, initiating a change in the holding temperature within the bin by changing the amount of power supplied to the heater, initiating a holding profile for the tray, prompting a user for input, and initiating an audible or visual alarm or displaying visual indicators.

13. The method of claim 12, wherein the storage bin is a plurality of storage bins, each having a reader and a heater associated therewith, the method further comprising the step of determining whether a user has moved the tray from a first bin to a second bin.

14. The method of claim 13, wherein a processor initiates the timer, and if the user has moved the tray from a first bin to a second bin, the processor transfers information associated with the timer from the first bin to the second bin.

15. The method of claim 12, wherein the cabinet is a plurality of cabinets, each of the cabinets having a storage bin, and a heater and reader associated with the storage bin, and the method further comprises the step of determining whether a user has moved the tray from a first cabinet to a second cabinet.

16. The method of claim 15, wherein a processor initiates the timer, and if the user has moved the tray from a first bin to a second bin, the processor transfers information associated with the timer from the first cabinet to the second cabinet.

17. The method of claim 12, wherein the transceiver is a read-only device.

18. The method of claim 12, wherein the wherein the performing step is executed automatically after the user places the tray in the bin, without any further input from the user.
